(19) United States
(12) Patent Application Publication
(10) Pub. No.: US 2008/0250250 A1
(43) Pub. Date: Oct. 9, 2008

(54) Method and Apparatus for Using USB Flash Devices and Other Portable Storage as a Means to Access Prepaid Computing

(75) Inventors: William J. Westerinen, Issaquah, WA (US); Todd Carpenter, Monroe, WA (US); Stephen R. Drake, Seattle, WA (US); Mark Myers, Fall City, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/696,350

(22) Filed: Apr. 4, 2007

(51) Int. Cl. G06F 12/14

(52) U.S. Cl. 713/189

(57) ABSTRACT

A form of removable memory, such as a universal serial bus (USB) flash device (UFD), may allow secure storage of and access to a time balance of a pay-per-use or subscription computing system. A computing device may establish a secure connection to a portable secure computing device to access a stored time balance or other device-enabling, exhaustible data. During operation, the device may deplete the balance. Upon reaching a threshold depletion of the balance, the user may add more data to continue device use. The device may include a processor and a secure memory including identification and subscription data. Further, the device may store configuration data that may be used by the computer to bind the device to a particular subscription service or internet service provider.

### BACKGROUND

This Background is intended to provide the basic context of this patent application and is not intended to describe a specific problem to be solved.

Pay-as-you-go or pay-per-use and subscription business models have been used in many areas of commerce, from cellular telephones to commercial launderettes. In developing a pay-as-you go business, a provider, for example, a cellular telephone provider, offers the use of hardware (a cellular telephone) at a lower-than-market cost in exchange for a commitment to remain a subscriber to their network. In this specific example, the customer receives a cellular phone for little or no money in exchange for signing a contract to become a subscriber for a given period of time. Over the course of the contract, the service provider recovers the cost of the hardware by charging the consumer for using the cellular phone.

The pay-as-you-go business model is predicated on the concept that the hardware provided has little or no value, or use, if disconnected from the service provider. To illustrate, should the subscriber mentioned above cease to pay his or her bill, the service provider deactivates their account, and while the cellular telephone may power up, calls cannot be made because the service provider will not allow them. The deactivated phone has no “salvage” value, because the phone will not work elsewhere and the component parts are not easily salvaged nor do they have a significant street value. When the account is brought current, the service provider will reconnect the device to network and allow the subscriber to make calls.

This model works well when the service provider, or other entity taking the financial risk of providing subsidized hardware, has tight control on the use of the hardware and when the device has little salvage value. This business model does not work well when the hardware has substantial uses outside the service provider's span of control. Thus, a typical personal computer does not meet these criteria since a personal computer may have substantial uses beyond an original intent and the components of a personal computer, e.g. a display or disk drive, may have a significant salvage value.

In a typical pay-as-you-go computing system, a user purchases a code that is redeemable for a number of computing hours at a specially-equipped electronic device. The user may add time to an existing account balance by purchasing additional codes. However, to ensure security of the user's time balance and securely track consumed time, the system stores data representing the time balance in a secure module at the device itself. Storing the user's time balance on one device prevents the user from accessing computer services at any machine other than the device containing the account balance.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A form of removable storage, such as a universal serial bus (USB) flash device (UFD), may allow secure storage of and access to a time balance of a pay-per-use or subscription computing system. A computing device may establish a secure connection to a portable secure computing device to access a stored time balance or other device-enabling, exhaustible data. During operation, the device may deplete the balance. Upon reaching a threshold depletion of the balance, the user may add more data to continue device use. The device may include a processor and storage including identification and subscription data. Further, the device may store configuration data that may be used by the computer to bind the device to a particular subscription service or internet service provider.

### BRIEF DESCRIPTION OF THE FIGURES

FIG. 1 is an illustration of a computer that implements a method or includes an apparatus for using USB flash devices and other portable storage as a means to access prepaid computing;

FIG. 2 is a simplified and representative block diagram of a storage device to enable prepaid computing;

FIG. 3 is a simplified and exemplary block diagram of a system supporting a pay-per-use and subscription business model;

FIG. 4 is a simplified and exemplary block diagram of a method for enabling a secure computer using a portable storage device to monitor and store an amount of purchased access or subscription time in a prepaid computing system;

FIG. 5 is another simplified and exemplary block diagram of a method for enabling a secure computer using a portable storage device to monitor and store an amount of purchased access or subscription time in a prepaid computing system; and

FIG. 6 is a yet another simplified and exemplary block diagram of a method for enabling a secure computer using a portable storage device to monitor and store an amount of purchased access or subscription time in a prepaid computing system.

### SPECIFICATION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader. It is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the present invention's principles and concepts, further discussion of such software and ICs, if any, will be limited to the essentials with respect to the preferred embodiments.

Many prior-art high-value computers, personal digital assistants, organizers, and the like, are not suitable for secure subscription use without modification. The ability to enforce a contract requires a service provider, i.e., an “ISP” or other enforcement entity, to be able to affect a device's operation even though the device may not be connected to the service provider, e.g. connected to the Internet. A first stage of enforcement may include a simple pop up or other graphical interface warning, indicating the terms of the contract are nearing a critical point. A second stage of enforcement, for example, after pay-per-use minutes have expired or a subscription period has lapsed, may be to present a system modal user interface for adding value and restoring service. A provider's ultimate leverage for enforcing the terms of a subscription or pay-as-you go agreement is to disable the device. Such a dramatic step may be appropriate when it appears that the user has made a deliberate attempt to subvert the metering or other security systems active in the device.

Uses for the ability to place an electronic device into a limited function mode may extend beyond subscription and pay-per-use applications. For example, techniques for capacity consumption could be used for licensing enforcement of an operating system or individual applications.

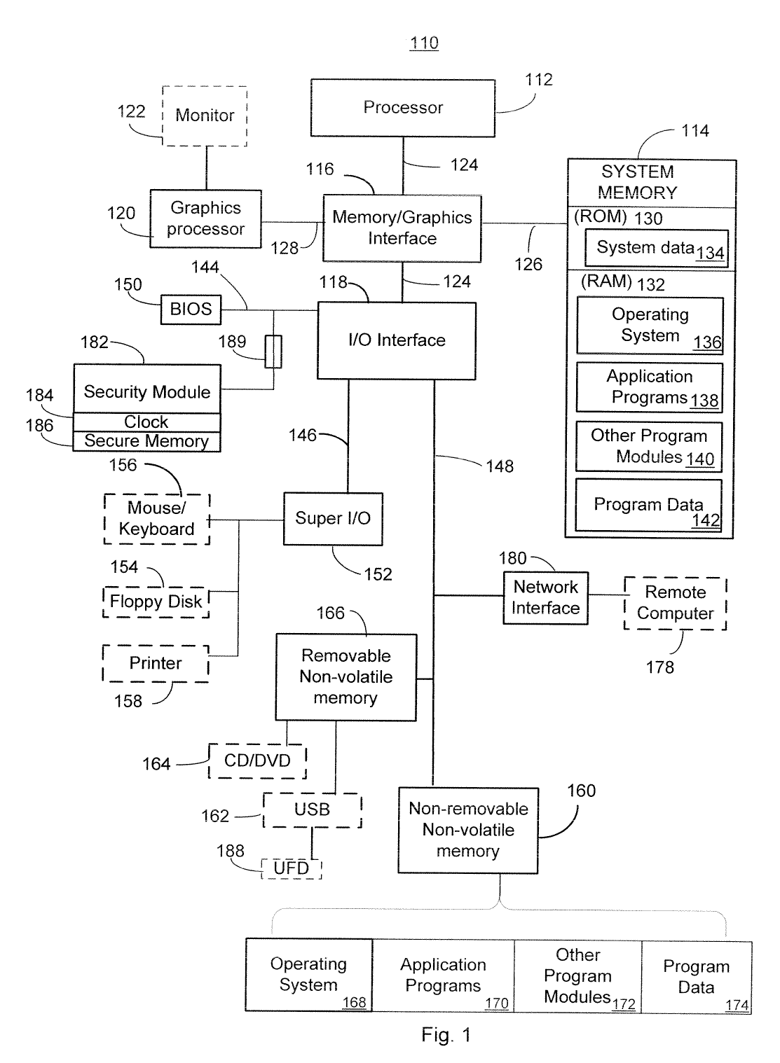

FIG. 1 illustrates a logical view of a computing device in the form of a computer 110 that may be used in a pay-per-use or subscription mode. For the sake of illustration, the computer 110 is used to illustrate the principles of the instant disclosure. However, such principles apply equally to other electronic devices, including, but not limited to, cellular telephones, personal digital assistants, media players, appliances, gaming systems, entertainment systems, set top boxes, and automotive dashboard electronics, to name a few. With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 112, a system memory 114, a memory/graphics interface 116, also known as a Northbridge chip, and an I/O interface 118, also known as a Southbridge chip. The memory 114 and a graphics processor 120 may be coupled to the memory/graphics interface 116. A monitor 122 or other graphic output device may be coupled to the graphics processor 120.

A series of system busses may couple various system components including a high speed system bus 124 between the processor 112, the memory/graphics interface 116 and the I/O interface 118, a front-side bus 126 between the memory/graphics interface 116 and the system memory 114, and an advanced graphics processing (AGP) bus 128 between the memory/graphics interface 116 and the graphics processor 120. The system bus 124 may be any of several types of bus structures including, by way of example, and not limitation, an Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

Computer 110 typically includes a variety of computer readable media. Computer readable media may be any available media that is accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 114 includes computer storage media in the form of volatile and/or nonvolatile memory such as read only memory (ROM) 130 and random access memory (RAM) 132. The system ROM 130 may contain permanent system data 134, such as identifying and manufacturing information. In some embodiments, a basic input/output system (BIOS) may also be stored in system ROM 130. RAM 132 typically contains data and/or program modules that are immediately accessible to and/or presently being operated on by processor 112. By way of example, and not limitation, FIG. 1 illustrates operating system 136, application programs 138, other program modules 140, and program data 142.

The I/O interface 118 may couple the system bus 124 with a number of other busses 144, 146, and 148 that join a variety of internal and external devices to the computer 110. A serial peripheral interface (SPI) bus 144 may connect to a basic input/output system (BIOS) memory 150 containing basic routines to help transfer information between elements within computer 110. For example, the BIOS may execute during start-up.

A super input/output chip 152 may be used to connect to a number of ‘legacy’ peripherals, such as floppy disk 154, keyboard/mouse 156, and printer 158. In one embodiment, the super I/O chip 152 is connected to the I/O interface 118 with a low pin count (LPC) bus 146. The super I/O chip is widely available in the commercial marketplace.

In one embodiment, bus 148 may be a Peripheral Component Interconnect (PCI) bus, or a variation thereof, may be used to connect higher speed peripherals to the I/O interface 118. A PCI bus may also be known as a Mezzanine bus. Variations of the PCI bus include the Peripheral Component Interconnect-Express (PCI-E) and the Peripheral Component Interconnect—Extended (PCI-X) busses, the former having a serial interface and the latter being a backward compatible parallel interface. In other embodiments, bus 148 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 1 illustrates a hard disk drive 160 that reads from or writes to non-removable, nonvolatile magnetic media. Removable media, such as a universal serial bus (USB) memory 162 or CD/DVD drive 164 may be connected to the PCI bus 148 directly or through an interface 166. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 160 is illustrated as storing operating system 168, application programs 170, other program modules 172, and program data 174. Note that these components can either be the same as or different from operating system 136, application programs 138 other program modules 140, and program data 142. Operating system 168, application programs 170, other program modules 172, and program data 174 are given different numbers here to illustrate that, at a minimum, they are different copies. A user may enter commands and information into the computer 110 through input devices such as a mouse/keyboard 156 or other input device combination. Other input devices (not shown) may include a microphone, joystick, game pad, satellite dish, scanner, or the like. These and other input devices are often connected to the processing unit 112 through one of the I/O interface busses, such as the SPI 144, the LPC 146, or the PCI 148, but other busses may be used. In some embodiments, other devices may be coupled to parallel ports, infrared interfaces, game ports, and the like (not depicted), via the super I/O chip 152.

The computer 110 may operate in a networked environment using logical connections to one or more remote computers, such as a remote computer 178 via a network interface controller (NIC) 180. The remote computer 178 may be a personal computer, a server, a router, a network PC, a peer device or other common network node, and typically includes many or all of the elements described above relative to the computer 110. The logical connection depicted in FIG. 1 may include a local area network (LAN), a wide area network (WAN), or both, but may also include other networks. Such networking environments are commonplace in offices, enterprise-wide computer networks, intranets and the Internet.

In some embodiments, the network interface may use a modem (not depicted) when a broadband connection is not available or is not used. It will be appreciated that the network connection shown is exemplary and other means of establishing a communications link between the computers may be used.

The computer 110 may also include a security module (SM) 182. The SM 182 may be enabled to perform security monitoring, pay-per-use and subscription usage management, and policy enforcement related to terms and conditions associated with paid use. The SM 182 may be particularly suited to securely enabling a computer 110 in a subsidized purchase business model. The SM 182 may be a set of virtualized containers executing on the processor 112 or real containers such as an embedded processor or controller. In one embodiment, the SM 182 is connected to I/O Interface 118 on the SPI bus 144. In another embodiment, the SM 182 may be embodied in the processing unit 112, as a standalone component, or in a hybrid, such as a multi-chip module. A clock 184 may be incorporated into the SM 182 to help ensure tamper resistance. To allow user management of local time setting, including daylight savings or movement between time zones, the clock 184 may maintain its time in a coordinated universal time (UTC) format and user time may be calculated using a user-settable offset. The SM 182 may also include a cryptographic function or a cryptographic core that may act as an authentication device for all communication between the SM 182 and other devices. For example, the cryptographic core of the SM 182 may provide a processing and encryption subsystem of the security module 182 that reaches a suitable Common Criteria Evaluation Assurance Level to ensure that the computer 110 and any communication with the SM 182 may not be compromised.

Additionally, the SM may include firmware and a form of secure memory or storage 186. The secure storage 186 may include routines or applications that may facilitate the secure operation of the computer 110 through the security module 182. Additionally, the secure storage 186 may include any other data that may be securely accessed, stored, or modified without unauthorized tampering. In one embodiment, the secure storage 186 includes a local provisioning module that manages the allocation of the usage time. The local provisioning module of the secure storage 186 may account for a user's pre-paid access time or subscription information and may be described by U.S. patent application Ser. No. 10/988,907, and U.S. patent application Ser. No. 11/612,433 the entire disclosure of which is hereby incorporated by reference. The secure storage 186 may also store encryption keys or other information to facilitate secure communication with the SM 182.

The storage 186 may also include storage for system-critical items such as a BIOS for a computer or other electronic device in which the SM 182 is operating. The secure storage 186 may also include memory dedicated to the operation of the SM 182 itself, such as storage, for example, for storing metering code to access and decrement subscription data. Further, an application for use in providing functionality during limited operation modes, such as a “hardware limited mode,” (HLM) may also be stored in the secure storage 186. To support a limited operation mode, a second BIOS, and optionally, an alternate copy of the second BIOS, may also be stored in the secure storage 186. The second BIOS may be used for booting the computer or other electronic device incorporating the SM 182. The second BIOS may be activated as a secure boot environment to replace the standard BIOS 150 to enforce a subscription or other security policy. Furthermore, the SM 182 may also have an ability to force a system reset at any time which may ensure that pay per use or subscription terms are met, as well as provide a clean environment to start with either a normal or a restricted operation BIOS.

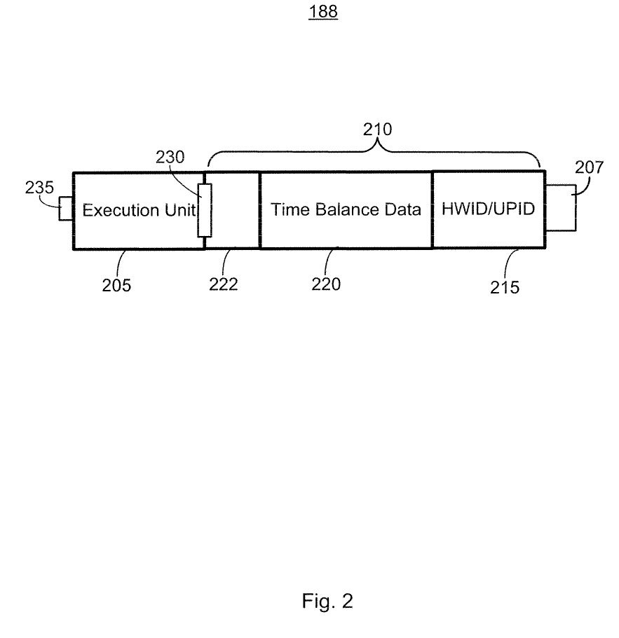

Another device 188 may store user identification and data related to a subscription account balance to enable a computer 110 equipped with a SM 182. In one embodiment, a metering application stored in the secure storage 186 of the SM 182 may communicate with a metered computing device 188 to access the identification and subscription account balance data. With reference to FIG. 2, the metered computing device 188 may be any form of removable memory. In one embodiment, the metered computing device 188 is universal serial bus (USB) flash drive (UFD). The metered computing device 188 may include an execution unit 205 that may include a processor to establish a secure connection with the SM 182. In one embodiment, upon startup or insertion of the metered computing device 188, the SM 182 and the metered computing device 188 establish a secure communication channel by a public key infrastructure (PKI). The metered computing device 188 may communicate with the SM 182. In one embodiment, the device 188 communicates with the SM 182 through an interface of the computer 110. The memory device may communicate with the computer 110 through any combination of 1394, USB, Internet Small Computer Systems Interface, serial, parallel, infrared, Near Field Communication, BlueTooth, 802.x, or other connection.

In a further embodiment, the device 188 communicates with the security module 182 through a BIOS 150 or a secure pre-boot environment stored in the SM 182 secure storage 186, as further explained below. In a still further embodiment, the metered computing device 188 communicates with the SM 182 through an API running on the computer 110. The SM 182 may force the computer 110 to reset when a metered computing device 188 containing subscription data is removed.

Other embodiments may include an activation fuse 189. The fuse 189 may be any type of device or firmware that may be selectively activated from an inactive state to enable communication between the I/O Interface 118 and the SM 182. When deactivated, i.e., when the fuse 189 does not maintain a connection between the SM 182 and the I/O Interface 118, the computer 110 may not operate as a subscription-based computing device, but rather, as a normal PC. However, when activated, i.e., when the fuse 189 maintains a connection between the SM 182 and the I/O Interface 118, the computer may operate as a subscription-based computing device. In one embodiment, the fuse 189, once activated to enable communication between the SM 182 and other components and devices, may not be deactivated. For example, the computer 110 may be manufactured initially to operate as a normal, non-subscription-based PC and may later be activated by an underwriter or subscriber to operate as a subscription-based PC. Therefore, while the fuse is activated and upon boot-up, connection, or disconnection of the device 188, firmware of the SM 182 (i.e., the previously-described local provisioning module of the secure storage 186) may seek subscription or usage time stored in the metered computing device 188.

Returning to FIG. 2, the device 188 as illustrated may be represented and arranged in a variety of forms to include the elements as described below. For example, the device 188 may include an interface 207 that may enable communication between the device 188 and the SM 182. As previously described, the device 188 may communicate with the computer 110 via the SM 182 through any combination of 1394, USB, Internet Small Computer Systems Interface, serial, parallel, infrared, Near Field Communication, BlueTooth, 802.x, or other connection. In one embodiment, the interface 205 is a male type-A USB connector that provides an interface to the host computer 110.

The device 188 may also include a memory or storage area 210. The storage area 210 may be a single flash memory chip or multiple flash memory chips that store a unique hardware identification (HWID) or Universal Property Identifier (UPID) 215. The HWID or UPID may uniquely identify the device to any other connected device, for example, a computing device 110 or remote computing device 178. In a further embodiment, the device 188 may store data representing a user's subscription or access data 220 to enable a computer 110 or to execute metered applications. Additionally, the storage area 210 may include configuration data 222. In one embodiment, the configuration data may provide information that may bind a computer 110 that is enabled with the device 188 to a particular internet service provider (ISP).

Also, as previously discussed, the metered computing device 188 may include an execution unit 205 that may enable a secure connection between the device 188 and any other device, for example, a computer 110. In one embodiment, the execution unit 205 includes a cryptographic function, as previously described in relation to the secure storage 186 of the SM 182. The cryptographic function of the device 188 that may act as an authentication module for all communication between the device 188 and the computer 110. For example, the cryptographic function of the execution unit 205 may provide a processing and encryption subsystem of the device 188 that reaches a suitable Common Criteria Evaluation Assurance Level to ensure that the device 188 and any communication between the device 188 and the computer 110 may not be compromised. In one embodiment, the cryptographic core and the execution unit 205 operates as the SLE series of smartcards as produced by Infineon Technologies AG of Munich, Germany.

Other embodiments of a metered computing device 188 include a battery 230 to preserve certain data of the storage 210 or may provide a power source for an indicator 235 that may be activated when the subscription data 220 reaches a threshold or the device 188 is compromised or may no longer function. Several indicator LEDs 235 may convey different notifications to the user, for example, a notification of a low time 220 or other usage balance or a notification of a full or adequate balance. The indicator 235 may also include a video screen that conveys a numerical balance of access time remaining on the device 188 or any other information related to any data stored on the device 188.

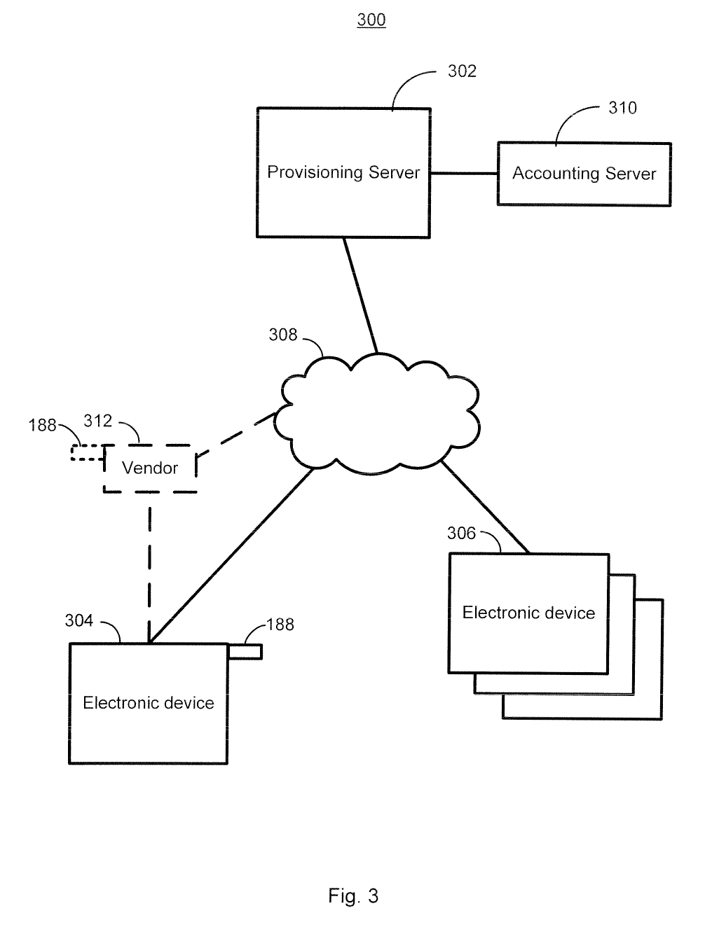

FIG. 3 is a simplified and exemplary block diagram of a system 300 supporting pay-per-use and subscription usage of a computer or other electronic device. A provisioning server 302 may serve as a trusted endpoint for provisioning requests from one or more electronic devices participating in the pay-per-use business ecosystem. One electronic device 304 may be similar to computer 110 of FIG. 1 with a connected metered computing device 188. Other electronic devices 306 may perform substantially the same as the exemplary device 304. Communication between the provisioning server 302 and the electronic device 304 may be accomplished through a network 308 that may include landline, wireless, or broadband networks, or other networks known in the art.

An accounting server 310 may be linked to the provisioning server 302 and may maintain account data corresponding to the electronic device 304. Account data may also be stored at the device 188. The accounting server 310 may also serve as a clearinghouse for financial transactions related to the electronic device 304, such as, replenishing or adding value to a pay-per-use account maintained on the accounting server 310 and recorded at the device 188. In one embodiment, the electronic device 304, enabled with the metered computing device 188, establishes a connection with a vendor 312 that communicates with the accounting server 310. In another embodiment, the metered computing device 188 establishes a connection directly with the accounting server 310. The vendor may be a vending machine or other stand-alone, self-service kiosk. A user may plug the metered computing device 188 directly into the vendor 312, select an amount of OS, application, or other subscription time for loading to the device 188, pay, and receive the access data. The access data may be any value, access time 220 to any secure OS or application of the electronic device 304, 306, or any other data that may be recorded at the accounting server 310 and stored at the device 188 for use with a computer 110. In a further embodiment, the user may purchase a generic amount of time that may be used for any OS, application, or any other activity at a secure electronic device 304. Of course, many other types of data, access time, and subscription information may be purchased and stored on the metered computing device 188.

In one scenario, a user desiring to add time to a device 188 may connect the device 188 to a vendor 312 at a retail outlet or through another computer 110, navigate through a series of UIs to pay for access time 220, and load time 220 to the device 188. The user may then use the purchased time 220 at a secure computing client 110 by connecting the device 188 to the computer 110. The device 188 may then establish a secure connection with the computer 110 which may, in turn, transmit a code to a server 302 which returns a signed packet to the computer 110. The packet may contain the data representing the amount of time 220 the user purchased. The computer 110 may consume the access time 220 of the device 188, transferring it to the LPM (Lower Provisioning Module) of the secure storage 186 and the time balance 220 may be updated. As previously explained, the LPM may be executed in a security module 182 or other hardware or hardware-assisted “container” in the system 110. In one embodiment, the LPM accesses and updates purchased time balances provided in the device 188. In another embodiment, the LPM synchronizes a time balance of the device 188 with a balance stored locally in the secure storage 186. When the purchased time 220 expires or is consumed on the computer 110, the user may be given several warnings that may be accompanied by reduced computer 110 functionality. If the user does not pay for more access time 220, the computer 110 ultimately transitions to a mode where the user may be presented with a text-only interface that may only allow him to connect a replenished device 188. In this state, which may be referred to as Hardware Locked Mode (HLM), the computer 110 may be unusable for anything but connecting a valid device 188. The computer 110 may enforce HLM by only operating in System Management Mode (SMM) which may not permit operating systems or applications to load other than a restricted HLM BIOS and associated code.

In another scenario, the user purchases an amount of time to use metered software on the computer 110 such as an OS, applications, or both. The user may also purchase the ability to use a metered word processing or other applications stored at the computer 110 for a number of uses, a number of completed pages, or any other measurable use. Once the user depletes the purchased usage 220 for an application, a user may not access the application from the computer 110 unless more time is purchased. In one embodiment, applications at the device 304, 306 are stored in a secure storage area 186 in a manner that may not install or store the application on a hard disk drive 160 of the computer 110. For example, the applications at the computer 110 may be in a Softgrid® format as produced by the Microsoft Corporation of Redmond, Wash.

A user may transfer his or her access to a computer 110 in a pay-for-use system to any computer 110 configured to access the metered computing device 188. In one embodiment, the user transports his or her usage time to a computer 110 in an internet café including machines with a security module 182. The café computer 110 may function only if a patron connects a metered computing device 188 that includes valid access time data 220. Other prepaid account funds transfer systems are well known, for example, with respect to prepaid cellular phones or other mobile computing systems, and are equally applicable in this business model.

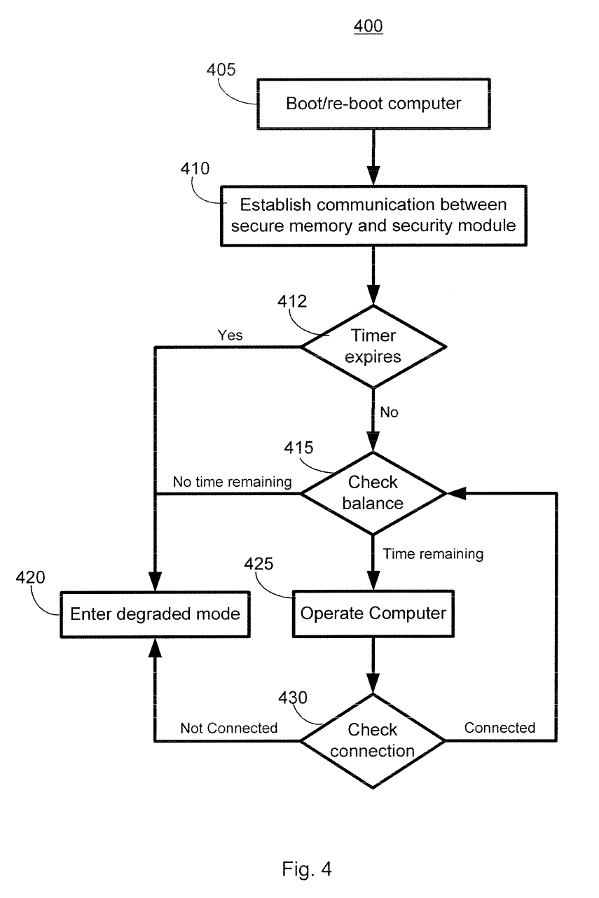

FIG. 4 is a simplified and exemplary block diagram of a method 400 for enabling a secure computer 110 using a portable memory device 188 to monitor and store an amount of purchased access or subscription time 220 for operating systems, 136, 168, application programs 138, 170, other program modules 140, 172, and other data 142, 174. The method 400 comprises a number of actions represented graphically in FIG. 4 as blocks. The actions may be executed in any suitable order to accomplish the described task. At block 405, the computer 110 may boot or re-boot. For example, if, before the computer 110 is turned on, the user connects the device 188, the computer 110 may be configured by its BIOS 150, to check for a connection with a device 188 during boot up. If the user connects the device 188 after boot up, the computer 110 may re-boot to begin operating with the device 188.

The boot process may involve following a normal boot sequence known in the art, with the exception that a request for BIOS code from the I/O Interface 118 may not result in reading BIOS boot code directly from memory, such as memory 150, but may result in a request from the I/O Interface 118 to the SM 182 for BIOS boot code stored in the secure storage 186 such as a secure boot environment BIOS. In one embodiment, the I/O Interface accesses the BIOS of the SM 182 only if the fuse 189 is activated, as previously described.

At block 410, communication between a device 188 and the computer 110 may be established. In one embodiment, communication between the device 188 and the computer 110 may be secure. For example, a secure channel may be established between the device 188 and the computer 110 by least one of the previously described cryptographic core of the SM 182 secure storage 186 and the cryptographic function of the device 188 execution unit 205. The HWID/UPID 215 of the device 188 may also be confirmed by the SM 182 to establish secure communication.

In a further embodiment, one of a dedicated or a hardware switched communication port may be used to establish secure communication between the device 188 and the computer. The dedicated path may be created between the device 188 and the SM 182 at boot up and may be a USB communication path that directly connects the device 188 to the SM 182. During operation, the device 188 remains attached to the port, directly connecting it to the SM 182 during operation. A heartbeat signal exchanged between the SM 182 and the device 188 may be monitored by firmware of the SM 182 to ensure secure communication maintenance.

Alternatively, switching hardware may handle multiplexing of the path, with a secondary path using the OS as a proxy, once the computer 110 completes booting and establishes the secure channel. Because the switched path may also use the OS and various drivers as a pathway, a switch from the path may occur during boot up which may result in a security risk. To mitigate the possibility of a security risk, a watchdog timer may be included in the secure storage 186 of the SM 182. In one embodiment, the watchdog timer is set for a duration to account for OS and driver loading. If, at block 412, the watchdog timer expires before the secure channel is re-established through the OS, the computer 110 may be rebooted or transitioned into a degraded mode as described at block 420. In one embodiment, the watchdog timer recognizes a secure channel by receiving a heartbeat signal initiated by the SM 182 and sent to an OS proxy application, through USB storage stacks, and into the device 188. Using either the dedicated or switched path, the SM 182 delays a “power OK” signal to the processor 112 and loads the SM 182 with the Lower Provisioning Module (LPM) of the secure storage 186. The SM 182 may then exchange credentials with the device 188 by, for example, a public key infrastructure, over the established secure path.

At block 415, the SM 182 may check the balance of time 220 on the device 188. In one embodiment, an LPM of the secure storage 186 may access the device 188 to check the time balance 220. If there is no time remaining on the device or time is below a threshold, at block 420, the computer 110 may enter a degraded mode of operation. In one embodiment, the SM 182 forces the computer 110 into a progressively more degraded operational state that finally results in the computer 110 entering a Hardware Locked Mode, as previously described. A user interface of the Hardware Locked Mode may ask a user to connect a device 188 with a valid time balance. The computer 110 may enter a degraded mode by accessing a limited operation BIOS stored on the SM 182. Time may not be decremented from the device 188 while the computer 110 is in Hardware Locked Mode.

Additionally, the LPM may access the configuration data 222 of the device. In one embodiment, the configuration data 222 may allow the LPM to bind the device 188 to a particular ISP. For example, the configuration data 222 may by authentication keys implementing a PKI that may represent authentication and authorization between the user and the ISP. The keys may be exchanged during an initial provisioning of the device 188, for example, upon connection to the computer 110.

If, at block 415, time remains on the device 188, at block 425, the computer 110 may operate. In one embodiment, the computer may operate according to a normal operation BIOS accessed by the computer 110 from the SM 182 secure storage 186 or memory 150. A user's actions during operation may be regulated according to the subscription or other access data 220 stored on the device 188. For example, the user may have purchased access 220 for an operating system 136, 168, individual or groups of application programs 138, 170, or other modules 140, 172 stored on the computer 110. Further, the access time 220 may allow the user to operate applications stored at the secure storage 186 of the SM 182. As previously described, the operating system(s) and applications may be in a Softgrid® format that may be securely accessed by, though not stored on, the computer 110. Operation of the computer 110 may also include decrementing the access data 220 associated with executed programs. In one embodiment, the LPM of the SM 182 may continuously decrement and update the access data 220 of the device 188.

At block 430, the computer 110 may check the connection established with the device 188 at block 410. If the device 188 is no longer connected to the computer 110, it may transition to a degraded mode as described in relation to block 420. If the device 188 remains connected to the computer 100, the method 400 may transition to block 415 to re-check the balance and continue.

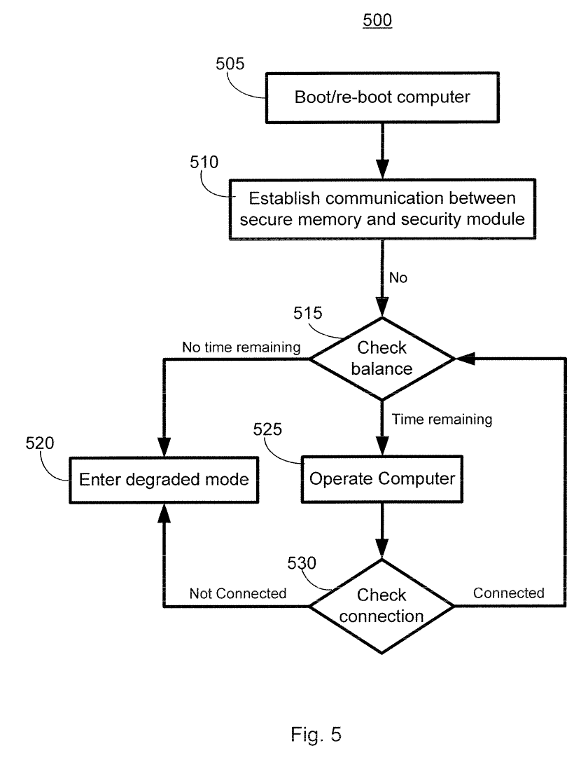

FIG. 5 is another simplified and exemplary block diagram of a method 500 for enabling a secure computer 110 using a portable memory device 188 to monitor and store an amount of purchased access or subscription time 220 for operating systems, 136, 168, application programs 138, 170, other program modules 140, 172, and other data 142, 174. At block 505, the computer 100 may boot or re-boot as described in relation to FIG. 4. As before, the SM 182 may delay a “power OK” signal to the I/O interface 118 to load the SM 182 with the LPM of the secure storage 186. However, as no secure channel is yet established, the LPM may not have access to any subscription or time data 220 of the device 188.

At block 510, the SM 182 may establish a secure channel with the device 188. In one embodiment, the SM 182 may load a secure boot environment stored in the secure storage 186. For example, the SM 182 may load a securely-configured BIOS from the secure storage 186. This BIOS may have routines to enumerate and connect a secure channel between the SM 182 and the device 188. In a further embodiment, the secure boot environment BIOS may be written with minimal code to mitigate potential security risks. The SM 182 may then exchange credentials with the device 188 to establish a secure channel.

At block 515, the SM 182 may check the balance of time 220 on the device 188 as described in relation to block 415. If there is no time remaining on the device, at block 520, the computer 110 may enter a degraded mode of operation. If, at block 515, time remains on the device 188, at block 525, the computer 110 may operate. As before, operation of the computer 110 may also include decrementing the access data 220 associated with executed programs. At block 530, the computer 110 may check the connection established with the device 188 at block 510. If the device 188 is no longer connected to the computer 110, it may transition to a degraded mode 520 as described in relation to block 420. If the device 188 remains connected to the computer 110, the method 500 may transition to block 515 to re-check the balance and continue.

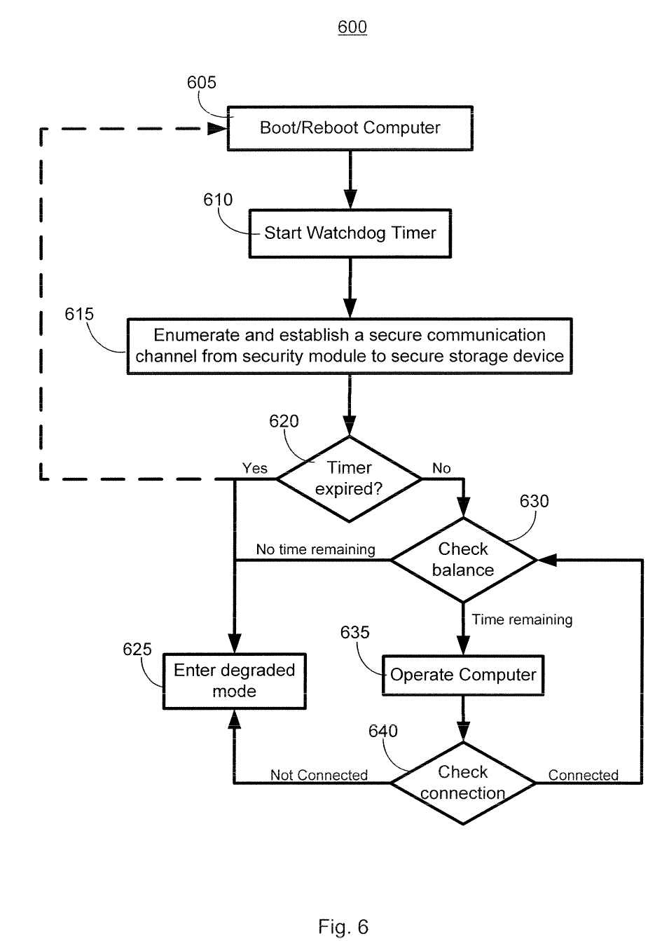

FIG. 6 is another simplified and exemplary block diagram of a method 600 for enabling a secure computer 110 using a portable memory device 188 to monitor and store an amount of purchased access or subscription time 220 for operating systems, 136, 168, application programs 138, 170, other program modules 140, 172, and other data 142, 174. At block 605, the computer 110 may boot normally, as if the LPM of the device 188 had already detected a positive balance at the device 188. At block 610, the SM 182 may initiate a watchdog timer that may monitor for a heartbeat signal from the device 188 within an amount of time. In another embodiment, the watchdog timer may monitor for the heartbeat signal though an established secure channel between the SM 182 and the device 188. In one embodiment, the watchdog timer is stored and executed within the secure storage 186 of the SM 182. Once boot is complete, at block 615, software executing within the loaded OS may establish a secure channel from the SM 182 to the device 188. In another embodiment, the SM 182 exchanges credentials with the device 188 and initiates the heartbeat signal.

If, at block 620, the watchdog timer has expired before it receives a heartbeat signal indicating an established secure channel between the SM 182 and the device 188, then, at block 625, the SM 182 may force the computer 110 into a degraded operation mode. Alternatively, at watchdog timer expiration, the SM 182 may force the computer 110 to reboot. If, however, the watchdog timer has not expired, at block 630, the method 600 may operate as described in relation to FIGS. 4 and 5.

At block 630, the SM 182 may check the balance of time 220 on the device 188 as described in relation to block 415. If there is no time remaining on the device, at block 625, the computer 110 may enter a degraded mode of operation. If, at block 630, time remains on the device 188, at block 635, the computer 110 may operate. As before, operation of the computer 110 may also include decrementing the access data 220 associated with executed programs. At block 640, the computer 110 may check the connection established with the device 188 at block 615. If the device 188 is no longer connected to the computer 110, it may transition to a degraded mode as described in relation to block 420. If the device 188 remains connected to the computer 110, the method 600 may transition to block 630 to recheck the balance and continue.

Thus, a device 188 may enable a secure computer 110 by securely storing an amount of purchased access or subscription time 220 for operating systems, 136, 168, application programs 138, 170, other program modules 140, 172, and other data 142, 174. By ensuring a secure channel of communication between a security module 182 of the computer 110 and the device 188, users of a subscription-based or pay-as-you-go computing system may enable any secure computer 110 with subscription and access information stored on a portable memory device 188.

Many modifications and variations may be made in the techniques and structures described and illustrated herein without departing from the spirit and scope of the present invention. Accordingly, it should be understood that the methods and apparatus described herein are illustrative only and are not limiting upon the scope of the invention

1. A system for enabling a subscription-based computer comprising:
a removable metered computing device including a cryptographic unit and a secure memory storing a number of subscription metering units;
a security module residing on the computer in communication with the removable metered computing device, the security module including a computer-readable medium having computer executable instructions comprising:
a communication module for establishing a secure communication channel between the removable metered computing device and the security module;
a provisioning module for accessing, decrementing, and storing the number of subscription units during operation of the subscription-based computer;
an authentication module in communication with the cryptographic unit for verifying the secure communication channel; and
a processing module for enabling execution of at least one application by the computer if the secure communication channel is verified and the number of subscription units remains above a threshold.

2. The system of claim 1, wherein the secure communication channel comprises a dedicated path between the removable metered computing device and the security module.

3. The system of claim 1, wherein the secure communication channel comprises a hardware switched communication port between the removable metered computing device and the security module.

4. The system of claim 3, wherein the hardware switched communication port includes a computer-readable medium having computer executable instructions comprising:
a multiplexing module for securely communicating between the removable metered computing device and the security module over a selected one of a dedicated path and an operating system of the computer.

5. The system of claim 1, further comprising a watchdog timer module for measuring an amount of time to load the operating system and drivers of the computer.

6. The system of claim 5, further comprising a disabling module for restricting the execution of the at least one application if the amount of time measured by the watchdog timer module is above a threshold.

7. The system of claim 1, further comprising a binding module for limiting access of the computer to at least one internet service provider.

8. The system of claim 1, wherein the communication module further comprises a secure boot environment module for enumerating and connecting the secure communication channel between the removable metered computing device and the security module.

9. The system of claim 1, wherein, through the secure connection, the removable metered computing device communicates only with the security module.

10. A method for enabling a subscription-based computer including a security module comprising:
connecting a removable metered computing device including a number of metered access units to the security module of the subscription-based computer;
securing the connection between the metered computing device and the security module;
determining if the number of metered access units is above a threshold;
restricting a function of the computer if the number of metered access units is below a threshold;
executing at least one application by the computer if the number of metered access units is above a threshold;
maintaining the secure connection between the metered computing device and the security module during execution of the at least one application; and
decrementing the number of metered access units during execution of the at least one application.

11. The method of claim 10, wherein the connection between the metered computing device and the security module comprises a dedicated path.

12. The method of claim 10, further comprising multiplexing the connection between one of a dedicated path and an operating system of the computer;
measuring an amount of time to load the operating system and drivers of the computer; and
restricting the execution of the at least one application if the amount of time measured is above a threshold.

13. The method of claim 10, wherein the removable metered computing device includes service provider configuration data.

14. The method of claim 13, further comprising identifying a service provider and provider access data from the service provider configuration data; and
binding the computer to the identified service provider using the provider access data.

15. The method of claim 10, further comprising enumerating and connecting a secure channel between the removable metered computing device and the security module through a secure boot environment stored at the security module.

16. A system including a removable metered computing device in communication with a security module of a subscription-based computer, at least one of the removable metered computing device and the security module including a protected memory and a protected processor physically configured to execute computer executable code for:
establishing a secure connection between the removable metered computing device and the security module of the subscription-based computer;
communicating a number of metered access units from the removable metered computing device to the security module;
executing at least one application of the computer if the number of metered access units is above a threshold; and
restricting a function of the computer if the number of metered access units is below a threshold.

17. The system of claim 16, wherein the connection between the removable metered computing device and the security module comprises a dedicated path.

18. The system of claim 16, further comprising computer executable code for:
multiplexing the secure connection between one of a dedicated path and an operating system of the computer;
measuring an amount of time to load the operating system and drivers of the computer; and
restricting the execution of the at least one application if the amount of time measured is above a threshold.

19. The system of claim 16, wherein the removable metered computing device includes service provider configuration data.

20. The system of claim 19, further comprising computer executable code for:
identifying a service provider and provider access data from the service provider configuration data; and
binding the computer to the identified service provider using the provider access data.
